(19) United States
(12) Patent Application Publication
(10) Pub. No.: US 2020/0172240 A1
(43) Pub. Date: Jun. 4, 2020

(54) FLAPPING WING AERIAL VEHICLE

(71) Applicant: Flapper Drones B.V., Delft (NL)

(72) Inventor: Matej KARASEK, Delft (NL)

(73) Assignee: Flapper Drones B.V., Delft (NL)

(21) Appl. No.: 16/615,047

(22) PCT Filed: May 15, 2018
(86) PCT No.: PCT/NL2018/050317

§ 371 Date: Nov. 19, 2019

(30) Foreign Application Priority Data
May 22, 2017 (NL) 2018958

(51) Int. Cl. B64C 33/02; B64C 39/02; B64C 13/34

(52) U.S. Cl. CPC B64C 33/025; B64C 13/34; B64C 39/028

(57) ABSTRACT

A flapping wing aerial vehicle comprises at least a first and second wing, a support structure, to which the wings are connected, at least one flapping mechanism, comprising at least a first spar and a flapping actuator, the at least first spar being attached to the wing membrane of the first wing and/or the second wing, the flapping actuator being configured to pivot said at least one spar with respect to a flapping pivot axis substantially parallel to a Z-axis for inducing a flapping motion of said first wing and/or second wing; a first attitude control mechanism, configured to induce a pitch moment; a second attitude control mechanism, configured to induce a yaw moment; a third attitude control mechanism, configured to induce a roll moment; and an attitude controller, wherein the first attitude control mechanism, the second attitude control mechanism, and the third attitude control mechanism are separate mechanisms.

The present invention relates to a flapping wing aerial vehicle, FWAV, comprising at least a first wing and a second wing, a support structure, at least one flapping mechanism, a first, second, and third attitude control mechanism, and an attitude controller.

FWAVs have been flying successfully for over a decade, but are until now mostly developed by universities.

One example of an FWAV is for example described in WO2010/141916. Disclosed herein is a heavier-than-air aircraft having flapping wings, wherein angular orientation control is effected by variable differential sweep angles of deflection of the flappable wings in the course of sweep angles of travel. More specifically, WO2010/141916 discloses an FWAV wherein left and right airfoils can be deflected to change the angle of attack of the corresponding wing. A leading edge beam can be pivoted with respect to a deflection axis that is substantially parallel to the spanwise wing direction.

WO2010/141916 describes how the deflection angle can be fixed during a forward and/or backward stroke of the airfoil, the left airfoil having a deflection angle that is different from the deflection angle of the right airfoil. This results in a roll moment. WO2010/141916 further describes how the deflection angle of the left airfoil and the right airfoil can be changed during a forward and backward stroke of said airfoils, in opposite directions, to generate a yaw moment. WO2010/141916 further describes how a pitch moment can be generated by cyclically changing the angles of deflection of the airfoils, e.g. by deflecting both the left airfoil and the right airfoil less in the beginning of a forwards stroke of the wings than the deflection thereof at the end of the forward stroke. The deflection then grows larger as the wings sweeps forward. Accordingly, the wings each generate more thrust upward during the beginning of the forward stroke than at the end of the forward stroke, and a pitch moment is generated.

Hence, all three control moments of roll, pitch, and yaw are generated by deflecting the airfoil, for which one control mechanism is provided. More specifically, all three control moments of roll, pitch, and yaw are generated by influencing the angle of attack of the wings of the FWAV as the wing flaps.

A disadvantage of the FWAV of WO2010/141916 is that the inducement of one of the attitude control moments of roll, yaw and pitch is cross-coupled with the inducement of at least one of the other attitude control moments.

It is an object of the invention to provide an improved flapping wing aerial vehicle. More specifically, it is an object of the invention to provide a flapping wing aerial vehicle wherein the attitude control moments of yaw, pitch, and roll are minimally coupled or even decoupled.

Therefore, a flapping wing aerial vehicle is provided for which an imaginary right-hand sided axis system comprising an X-axis, a Y-axis, and a Z-axis is defined, the flapping wing aerial vehicle comprising:
at least a first wing and a second wing, the second wing being opposite to the first wing, each wing comprising a wing membrane, a root section, and a leading edge section;
a support structure, to which the wings are directly or indirectly connected, the support structure extending substantially parallel to the Z-axis;
at least one flapping mechanism, comprising at least a first spar and a flapping actuator, the at least a first spar being attached to the wing membrane of the first wing and/or the second wing, the flapping actuator being configured to pivot said at least one spar with respect to a flapping pivot axis substantially parallel to the Z-axis for inducing a flapping motion of said first wing and/or second wing;
a first attitude control mechanism, configured to induce a pitch moment to the flapping wing aerial vehicle;
a second attitude control mechanism, configured to induce a yaw moment to the flapping wing aerial vehicle;
a third attitude control mechanism, configured to induce a roll moment to the flapping wing aerial vehicle;
an attitude controller, configured to generate respectively a pitch control signal for controlling said first attitude control mechanism to induce a pitch moment, a yaw control signal for controlling said second attitude control mechanism to induce a yaw moment, and roll control signal for controlling said third attitude control mechanism to induce a roll moment;
   wherein the first attitude control mechanism, the second attitude control mechanism, and the third attitude control mechanism are separate mechanisms,
   wherein the first wing comprises a first leading edge spar and the second wing comprises a second leading edge spar, said first and second leading edge spars being pivotable with respect to a first pivot axis substantially parallel to the Z-axis, allowing the dihedral angle of the corresponding wing to be changed,
   wherein the first attitude control mechanism comprises a first actuator, configured to pivot the first and second leading edge spars simultaneously in substantially the same direction with respect to a YZ-plane, for inducing a pitch moment to the flapping wing aerial vehicle, and
   wherein the first actuator is configured to pivot the first and second leading edge spars and the flapping actuator with respect to said first pivot axis.

Advantageously, by providing three separate attitude control mechanisms, each attitude control mechanism being configured to induce at least a pitch moment, respectively a roll moment, respectively yaw moment, such that the three attitude control moments can each be induced by a different attitude control mechanism, the generation of each one of the attitude control moments is substantially uncoupled from the other attitude control moments. This makes it possible to perform stable flight in all flight conditions, including hovering flight, forward flight, and turning. Furthermore, by controlling the three attitude control moments precisely, attitude control at low speeds, including hover, becomes possible, also for prolonged time periods.

With an FWAV according to the invention, having three attitude control mechanism that are separate from each other, an FWAV is provided that can be stably controlled in substantially all flight conditions without the need for a tail structure, i.e. the FWAV according to the invention may be tail-less. This leads to a compact, small, and light FWAV.

By providing an FWAV comprising a first, a second, and a third attitude control mechanism, a highly agile FWAV results, allowing for aggressive flight manoeuvres. According to some embodiments of the present invention, a pitch rate of up to 900 deg/s and/or a roll rate of up to 1350 deg/s may be achieved with stable recovery.

Further advantageously, some embodiments of the present invention allow the use of simple, readily available components to construct all components of the FWAV. As such, the FWAV according to some embodiments of the invention may be mass-produced at a relatively cheap price.

As will be described below, at least one of the control moments may advantageously be generated instantaneously for some embodiments of the FWAV according to the invention. The flapping wing MAV according to the invention, in general, is able to perform both vertical and horizontal flight. This horizontal flight may be done with a velocity of up to or more than 4 m/s.

As is the convention in the art, in steady, hovering flight, the positive X-axis of the MAV points forward. The positive Z-axis points down in this steady, hovering flight condition, and the positive Y-axis then points to the right, completing the right-hand sided axis system. It should be understood by those skilled in the art that it is also possible to make turns, to ascend and descend, and to make other flight manoeuvres besides only flying horizontally and vertically with the disclosed FWAV. Pure horizontal flight and pure vertical flight are not the limiting flight options.

The axis system is fixed with respect to the FWAV and is tilted when the flapping wing MAV transfers between horizontal and vertical flight, and vice versa. Therefore, some definitions are needed regarding the performed manoeuvres. Within the context of this disclosure, a pitch manoeuvre or moment is defined as a rotation or moment around the Y-axis of the flapping wing MAV; a roll manoeuvre or moment is defined as a rotation or moment around the X-axis of the flapping wing MAV; and a yaw manoeuvre or moment is defined as a rotation or moment around the Z-axis of the flapping wing MAV. This definition is maintained in all possible flight modes.

The flapping wing aerial vehicle may for example be a flapping wing micro aerial vehicle, an flapping wing nano aerial vehicle, or any other flapping wing aerial vehicle.

The FWAV according to the invention comprises at least a first wing and a second wing, the second wing being opposite to the first wing, each wing comprising a wing membrane, a root section, and a leading edge section. As such, embodiments are for example conceivable wherein the FWAV comprises a left wing and a right wing. Further embodiments are for example conceivable wherein the FWAV comprises a left wing pair, and a right wing pair, each pair comprising a front wing half and a back wing half, adjoined near the root section of the wing.

The FWAV according to the invention further comprises a support structure, to which the wings are directly or indirectly connected, the support structure extending substantially parallel to the Z-axis. For example, the at least two wings may be adjoined at the support structure, or the at least two wings may be arranged separate from each other, with a spacing between them, each wing having a root bar, which root bar is directly or indirectly connected to the support structure. The support structure may further provide an attachment for one or more actuators, a battery, an attitude controller, a flapping mechanism, and other components. Said components are preferably spread along a length of the support structure to optimize the location of the centre of gravity of the FWAV.

The FWAV according to the invention further comprises at least one flapping mechanism, said flapping mechanism comprising at least a first spar and a flapping actuator, the at least a first spar being attached to the wing membrane of the first wing and/or the second wing, the flapping actuator being configured to pivot said at least one spar with respect to a flapping pivot axis substantially parallel to the Z-axis for inducing a flapping motion of said first wing and/or second wing. For example, the FWAV may comprise one flapping mechanism, comprising a first spar and a second spar and a flapping actuator, wherein the first spar is attached to the wing membrane of the first wing or first wing pair, and wherein the second spar is attached to the wing membrane of the second wing or second wing pair. In another example, the FWAV comprises two flapping mechanisms, each comprising a spar and a flapping actuator. As such, there may be arranged a first flapping mechanism for inducing a flapping motion of a first wing or first wing pair, and a second flapping mechanism for inducing a flapping motion of a second wing or second wing pair. In yet another example, the spar may comprise two parts or portions, being separated from each other or being adjoined. For example, when the wing comprises a front and back portion, each of the front and back portion may comprise a spar.

The FWAV according to the invention further comprises a first attitude control mechanism, configured to induce a pitch moment to the flapping wing aerial vehicle. Preferably, the first attitude control mechanism is configured to induce only a pitch moment. Different attitude control mechanisms are known in the art that are configured to induce a pitch moment to a FWAV, including but not limited to attitude control mechanisms that are configured to alter the tension or shape of the wing membranes, that are configured to alter the inclination angle of the wings, that are configure to deflect the stroke plane of the wings, that are configured to alter the upstroke and/or downstroke speed of the wings and/or that are configured to alter the dihedral angle of the wings.

The FWAV according to the invention further comprises a second attitude control mechanism, configured to induce a yaw moment to the flapping wing aerial vehicle. Preferably, the second attitude control mechanism is configured to induce only a yaw moment. Different attitude control mechanisms are known in the art that are configured to induce a yaw moment to a FWAV, including but not limited to attitude control mechanisms that are configured to alter the tension or shape of at least one of the wing membranes, that are configured to alter the inclination angle of at least one of the wings, that are configure to deflect the stroke plane of at least one of the wings, and/or that are configured to alter the upstroke and/or downstroke speed of at least one of the wings.

The FWAV according to the invention further comprises a third attitude control mechanism, configured to induce a roll moment to the flapping wing aerial vehicle. Preferably, the third attitude control mechanism is configured to induce only a roll moment. Different attitude control mechanisms are known in the art that are configured to induce a roll moment to a FWAV, including but not limited to attitude control mechanisms that are configured to alter the tension or shape of at least one of the wing membranes, that are configured to alter the inclination angle of at least one of the wings, that are configured to alter the flapping amplitude of at least one of the wings, and/or that are configured to alter the flapping frequency of at least one of the wings.

The FWAV according to the invention further comprises an attitude controller, configured to generate respectively a pitch control signal for controlling said first attitude control mechanism to induce a pitch moment, a yaw control signal for controlling said second attitude control mechanism to induce a yaw moment, and roll control signal for controlling said third attitude control mechanism to induce a roll moment. The attitude controller may further generate a flapping control signal for controlling the actuation of the at least one flapping mechanism, such as the flapping amplitude and/or the flapping frequency.

The first attitude control mechanism, the second attitude control mechanism, and the third attitude control mechanism of the FWAV according to the invention are separate mechanisms. Hence, advantageously, each of the attitude control moments of pitch, roll, and yaw may be generated independently of the other attitude control moments. Further, the FWAV according to the invention allows the generation of combined control moments, e.g. a combined control input of both roll and pitch. This control input can be generated quickly and effectively when the respective control mechanisms are separate.

Although an FWAV comprising three attitude control mechanisms, generally, may be heavier than a FWAV comprising only one attitude control mechanism that is able to generate all three control moments of pitch, roll, and yaw, by decoupling the generation of the three control moments, and providing a dedicated attitude control system for each control moment, the overall performance of the FWAV may be increased. Further, the overall complexity of the FWAV may be reduced, and/or the part count may be reduced.

It is noted that, although the first, second, and third attitude control mechanism are preferably configured to induce only a pitch, yaw and roll moment, respectively, embodiments are conceivable wherein at least one of the first, second and third attitude control mechanisms is configured to induce at least one further attitude control moment. In the FWAV according to the invention, the first wing comprises a first leading edge spar and the second wing comprises a second leading edge spar, said first and second leading edge spars being pivotable with respect to a first pivot axis substantially parallel to the Z-axis, allowing the dihedral angle of the corresponding wing to be changed. The first leading edge spar and second leading edge spar may for example be pivotable in the same direction, simultaneously or independently to induce at least a pitching moment, and/or the first leading edge spar and second leading edge spar may be pivotable in opposite direction simultaneously or independently to induce at least a yawing moment.

In the FWAV according to the invention, the first attitude control mechanism comprises a first actuator, configured to pivot the first and second leading edge spars simultaneously in substantially the same direction with respect to a YZ-plane, for inducing a pitching moment to the flapping wing aerial vehicle. When both leading edge spars are simultaneously pivoted in substantially the same direction, e.g. forwards in a hovering position, i.e. in the direction of the positive X-axis, the lift vector generated by the first and second wings is synchronously moved forwards with respect to a centre of gravity of the FWAV, and a positive pitch moment is generated. Analogously, both leading edge spars can be pivoted backwards, i.e. in the direction of the negative X-axis, to generate a negative pitch moment.

It is noted that, where this document refers to a force or a moment, generated by the FWAV, for example a lift force or a pitch moment, in general a wing cycle averaged force or a wing cycle averaged moment is meant, i.e. the average force or moment that is generated during one cycle of a flapping motion of the wing. An embodiment is conceived comprising more than one, e.g. two, flapping actuators that can be operated at different flapping frequencies. For such an embodiment, the cycle averaged moment or cycle averaged force is defined as the average force or moment generated over the average duration of a wing cycle, measured over multiple wing cycles, e.g. measured over three or more wing cycles.

In the FWAV according to the invention, the first actuator is configured to pivot the first and second leading edge spars and the flapping actuator or mechanism with respect to said first pivot axis. The FWAV may for example comprise a first flapping mechanism, configured to flap the first wing, and a second flapping mechanism, configured to flap the second wing. The flapping actuators of the flapping mechanisms may then be arranged between the first leading edge spar respectively the second leading edge spar and the first actuator, such that the first actuator not only pivots the first and second leading edge spars with respect to the first pivot axis, but also pivots the first and second flapping actuators with respect to the first pivot axis.

According to an embodiment of the invention, the first actuator comprises a servomotor with at least a first pivoting arm, coupled to the first and second leading edge spars, respectively, for controlling said pivotal movement of said first and second leading edge spars. The first and second pivoting arms may for example be coupled via contra-rotatable gears, e.g. gear wheels, or any other synchronization mechanism, such as a friction element or a belt, such that the first and second pivoting arm move simultaneously and in the same direction, e.g. either forwards or backwards with respect to the YZ-plane when the FWAV is in the hovering position.

Any actuator comprising a rotating arm may however be used in alternative embodiments of the invention, such as for example a linear actuator with a push/pull rod.

According to an embodiment of the invention, the first wing and the second wing are spaced apart from each other and comprise a first root spar and a second root spar, respectively, attached to the root section of the respective wing membrane, and wherein the root spars are configured to pivot with respect to a second pivot axis that is substantially parallel to the Y-axis, allowing the inclination angle of the corresponding wing to be changed. Embodiments are conceivable where the inclination angle of the corresponding wing is substantially constant in spanwise direction, i.e. in the direction from the wing root to the wing tip, when the root spars are pivoted, but embodiments are also conceivable where the inclination angle of the corresponding wing changes from the root section to the tip section of the wing. The root spars of the first wing and the second wing may be pivoted in a similar direction, i.e. both forwards or backwards along the X-axis, inducing a pitch moment, or the root spars of the first wing and the second wing may be pivoted in mutually opposite directions, inducing a yaw moment.

According to an embodiment of the invention, the second attitude control mechanism comprises a second actuator configured to pivot the first and second root spars with respect to said second pivot axis in substantially opposite directions for inducing a yaw moment to the flapping wing aerial vehicle. By pivoting the first and second root spars in mutually opposite directions, the lift vector of the respective wings is tilted in mutually opposite directions, and at least a yaw moment may be induced.

According to an embodiment of the invention, the second attitude control mechanism further comprises a control arm arranged between the first wing and the second wing, the first root spar being coupled to said control arm near one end thereof, and the second root spar being coupled to said control arm near another, opposing, end thereof, wherein said second actuator is configured to pivot the control arm with respect to a third pivot axis that is substantially parallel to the Z-axis, and wherein a pivoting movement of said control arm increases the inclination angle of one of the first and second wings, and decreases the inclination angle of the other one of the first and second wings. The control arm may for example have a first hole near a first outer end thereof, and may have a second hole near a second outer end thereof, opposite of the first outer end. The first and second root bars may then extend through said holes, coupling the movement of the first and second root bars to each other. Preferably, the holes are larger in diameter than the diameter of the root bars, to provide some flexibility when the control arm is pivoted by the second actuator.

The control arm may for example be arranged near a trailing edge of the first wing and the second wing, respectively.

According to an embodiment of the invention, the second actuator comprises a servomotor with a pivoting arm, coupled to the first and second root spar, respectively, for controlling the movement of said first and second root spars. The pivoting arm may for example drive the movement of the control arm.

According to an embodiment of the invention, the third attitude control mechanism is configured to induce a rolling moment to the flapping wing aerial vehicle by changing the flapping motion of the first and/or the second wing, for example by providing a flapping frequency and/or a flapping range for the first wing that is different from that for the second wing. When the flapping motion of the first wing is changed compared to the second wing, or vice versa, in general the lift generated by said first wing becomes different from the lift generated by said second wing. This may induce at least a roll moment.

According to an embodiment of the invention, the FWAV comprises two flapping mechanisms, each flapping mechanism comprising a spar that is attached to the wing membranes of the first wing respectively the second wing and a flapping actuator, wherein the attitude controller is configured to control the flapping motion induced by each of the two flapping actuators separately. Hence, the two flapping mechanisms may act as the third attitude control mechanism, wherein the flapping mechanisms do not only provide lift, but additionally provide attitude control while the flapping motion of the first wing may be changed compared to the flapping motion of the second wing to induce a roll moment. Although the use of two flapping mechanisms may add more parts to the FWAV and may make it heavier than a FWAV that has only one flapping mechanism, the FWAV may become less complex and easier to produce. A control mechanism that allows for a differential flapping motion of the first wing compared to the second wing may be relatively complex, prone to break, and expensive to manufacture. Adding a second flapping mechanism that receives a separate control input, may hence lead to an overall simpler, more reliable and cheaper FWAV system.

According to an embodiment of the invention, the third attitude control mechanism comprises two flapping mechanisms, and the attitude controller is configured to send a first roll signal to the first flapping mechanism and a second roll control signal to the second flapping mechanism, e.g. to the flapping actuator.

According to an embodiment of the invention, the first attitude control mechanism is configured to induce only a pitch moment, and/or the second attitude control mechanism is configured to induce only a yaw moment, and/or the third attitude control mechanism is configured to induce only a roll moment. When each attitude control mechanism is configured to induce only one of the respective attitude control moments, each attitude control moment is provided for and each attitude control system can be relatively simple, providing a relatively simple FWAV. This may not only make the FWAV cheap to produce, but may additionally enhance the reliability of the FWAV.

According to an embodiment of the invention, the first wing and the second wing each comprise a front wing portion and a back wing portion, adjoined at the root section of the wing, wherein the front wing portion and the back wing portion are configured to move away from and towards each other when a flapping motion of the wing is induced. A “double wing”, compared to a “single wing” compensates some of the inertia forces induced by the flapping motion of the wings.

It is noted that the above description has given only a limited number of examples regarding the induction of an attitude control moment. It is noted that many other control mechanisms are known, each of these alternative control mechanisms being configured to generate at least one of the pitch, yaw and roll control moments. Such mechanisms were only briefly described. It is further noted that particular attitude control mechanisms have been described in the above, e.g. for inducing a yaw moment. Using a similar operational principle, these attitude control mechanisms may alternatively be used to induce a different attitude control moment, e.g. a pitch moment. The invention is not limited to the exemplary embodiments of attitude control mechanisms as described in the above.

As explained, providing a FWAV with two different flapping mechanisms that each receive a separate control input and that can be moved with respect to each other, possibly independently from each other, provides an attitude control system to achieve roll and/or pitch control moments to the FWAV. Such an attitude control system is not seen before, and may be seen as an invention in itself, independent of the subject-matter of claim 1.

Hence, a FWAV as a second, separate invention is also provided for which an imaginary right-hand sided axis system comprising an X-axis, a Y-axis, and a Z-axis is defined, the flapping wing aerial vehicle comprising:
at least a first wing and a second wing, the second wing being opposite to the first wing, each wing comprising a wing membrane and a root section;
a support structure, to which the wings are directly or indirectly connected, the support structure extending substantially parallel to the Z-axis; and
two flapping mechanisms, each flapping mechanism comprising a spar that is attached to the wing membranes of the first wing respectively the second wing and a flapping actuator, wherein an attitude controller is configured to control a flapping motion induced by each of the two flapping actuators separately.

It is noted that some or all features which have been or will be described in relation to the invention according to the claims, may also advantageously be used in combination with the second invention. More specifically, the subject-matter of at least each one of claims 2, 8, 9, 10 and 12, or the following subject matter: “the first wing comprises a first leading edge spar and the second wing comprises a second leading edge spar, said first and second leading edge spars being pivotable with respect to a first pivot axis substantially parallel to the Z-axis, allowing the dihedral angle of the corresponding wing to be changed, wherein the first attitude control mechanism comprises a first actuator, configured to pivot the first and second leading edge spars simultaneously in substantially the same direction with respect to a YZ-plane, for inducing a pitch moment to the flapping wing aerial vehicle, and wherein the first actuator is configured to pivot the first and second leading edge spars and the flapping actuator with respect to said first pivot axis” may advantageously be used in combination with the second invention.

A FWAV as a third, separate invention, focusing on the first attitude control mechanism and the first actuator, is also provided, for which an imaginary right-hand sided axis system comprising an X-axis, a Y-axis, and a Z-axis is defined, the FWAV comprising:
at least a first wing and a second wing, the second wing being opposite to the first wing, each wing comprising a wing membrane, a root section, and a leading edge section;
a support structure, to which the wings are directly or indirectly connected, the support structure extending substantially parallel to the Z-axis;
at least one flapping mechanism, comprising at least a first spar and a flapping actuator, the at least a first spar being attached to the wing membrane of the first wing and/or the second wing, the flapping actuator being configured to pivot said at least one spar with respect to a flapping pivot axis substantially parallel to the Z-axis for inducing a flapping motion of said first wing and/or second wing;
a first attitude control mechanism, configured to induce a pitch moment to the flapping wing aerial vehicle;
an attitude controller, configured to generate a pitch control signal for controlling said first attitude control mechanism to induce a pitch moment,
   wherein the first wing comprises a first leading edge spar and the second wing comprises a second leading edge spar, said first and second leading edge spars being pivotable with respect to a first pivot axis substantially parallel to the Z-axis, allowing the dihedral angle of the corresponding wing to be changed,
   wherein the first attitude control mechanism comprises a first actuator, configured to pivot the first and second leading edge spars simultaneously in substantially the same direction with respect to a YZ-plane, for inducing a pitch moment to the flapping wing aerial vehicle, and
   wherein the first actuator is configured to pivot the first and second leading edge spars and the flapping actuator with respect to said first pivot axis.

These and other aspects of the invention as claimed will be more readily appreciated as the same becomes better understood by reference to the following detailed description and considered in connection with the accompanying drawings in which like reference symbols designate like parts.

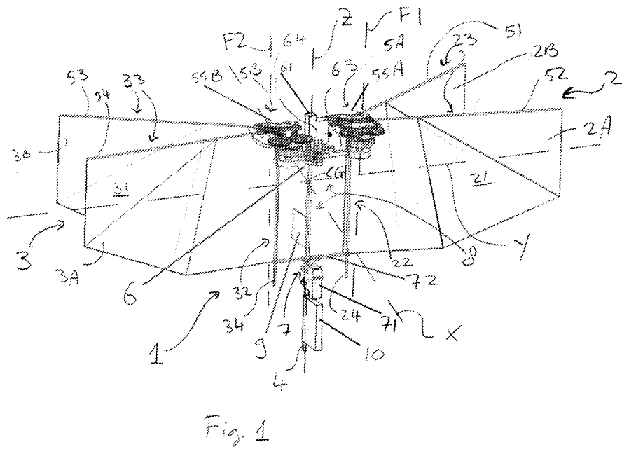

FIG. 1 schematically shows an isometric view of a flapping wing aerial vehicle according to the invention;

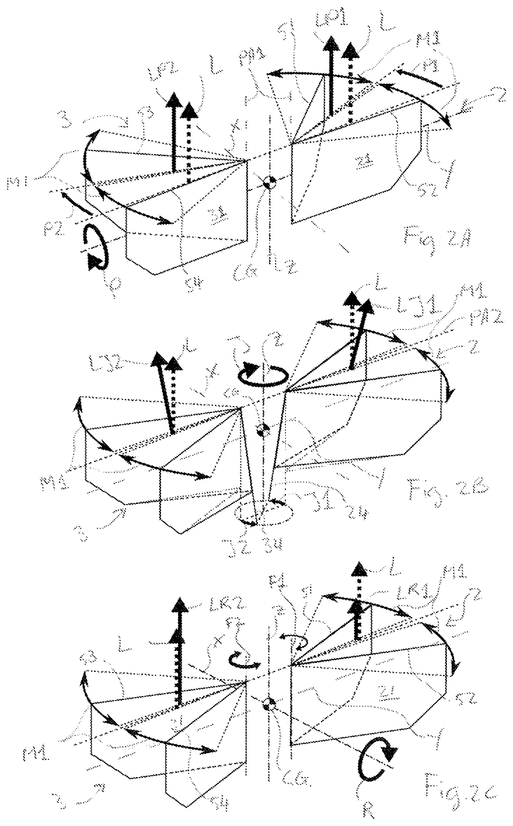

FIG. 2A schematically shows an effect of operating an embodiment of a first attitude control mechanism of a flapping wing aerial vehicle according to the invention;

FIG. 2B schematically shows an effect of operating an embodiment of a second attitude control mechanism of a flapping wing aerial vehicle according to the invention;

FIG. 2C schematically shows an effect of operating an embodiment of a third attitude control mechanism of a flapping wing aerial vehicle according to the invention;

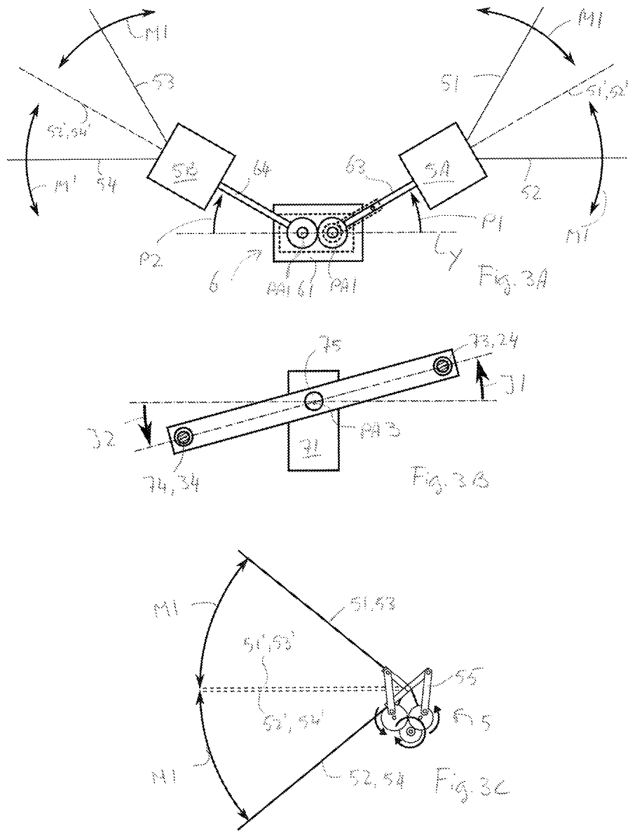

FIG. 3A schematically shows an embodiment of a first attitude control mechanism of a flapping wing aerial vehicle according to the invention;

FIG. 3B schematically shows an embodiment of a second attitude control mechanism of a flapping wing aerial vehicle according to the invention;

FIG. 3C schematically shows an embodiment of a flapping mechanism of a flapping wing aerial vehicle according to the invention; and

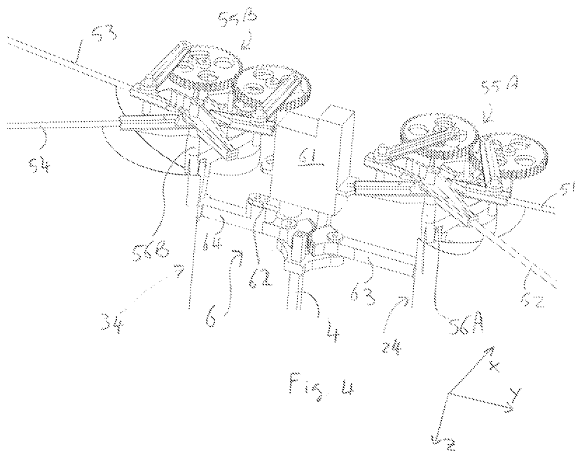

FIG. 4 schematically shows an isometric view of an embodiment of a first attitude control mechanism of a flapping wing aerial vehicle according to the invention.

Schematically shown in FIG. 1 is a flapping wing aerial vehicle, here a flapping wing micro aerial vehicle, FWMAV, for which an X-axis X, a Y-axis Y and a Z-axis Z is defined. In FIG. 1, the FWMAV is oriented substantially vertically, the positive X-axis X being directed substantially forwards. When hanging substantially still, this flight mode corresponds to a hovering position of the FWMAV. In this hovering position, the positive Y-axis Y points generally to the right, and the positive Z-axis Z generally points downwards.

It is desired that the FWMAV can manoeuvre with respect to this hovering position. For example, it is desired when the FWMAV can perform a roll manoeuvre, wherein the FWMAV rotates around the X-axis X, a pitch manoeuvre, wherein the FWMAV rotates around the Y-axis Y, and a yaw manoeuvre, wherein the FWMAV rotates around the Z-axis Z.

As can be seen in FIG. 1, the FWMAV comprises a first wing 2 and a second wing 3, the second wing 3 being opposite to the first wing 2. In the specific embodiment, the first wing 2 and the second wing 3 are wing pairs, the first wing 2 comprising a back wing portion 2A and a front wing portion 2B, adjoined at a root section 22 of the wing 2 and the second wing 3 also comprising a back wing portion 3A and a front wing portion 3B, adjoined at a root section 32 of the wing 3. The wings 2, 3 comprising a back wing portion 2A, 3A and a front wing portion 2B, 3B is not strictly necessary.

Both wings 2, 3 comprise a wing membrane 21, 31, a root section 22, 32, and a leading edge section 23, 33.

Each wing portion 2A, 2B, 3A, 3B comprises a spar 51, 52, 53, 54, respectively, arranged near the leading edge section 23, 33 of the wing 2, 3 and attached to the wing membranes 21, 31, thereof.

The spars 51, 52, 53, 54 each form a part of a flapping mechanism 5A, 5B, said flapping mechanism further comprising a flapping actuator 55A, 55B. The flapping actuators 55A, 55B are each configured to pivot the at least one spar 51, 52, 53, 54 with respect to a flapping pivot axis F1, F2 that is substantially parallel to the Z-axis Z for inducing a flapping motion of said first wing 2 and said second wing 3, respectively.

This flapping motion is better shown with respect to FIG. 3C, wherein a flapping mechanism 5 is shown, comprising a flapping actuator 55, a first spar 51, 53 and a second spar 52, 54. The spars 51, 52, 53, 54 are movable towards and away from each other between an extended position (shown in solid lines, corresponding to spars 51, 52, 53, 54) and a collapsed position (shown in dashed lines, corresponding to spars 51′, 52′, 53′, 54′) by activating the flapping actuator 55, inducing a flapping motion M1 of the corresponding respective wings. Hence, the front wing portion and the back wing portion, that are attached to the spars 51, 52, 53, 54 are configured to move away from and towards each other when a flapping motion M1 of the wing is induced. By flapping the wings, a lift force is produced.

As visible in FIG. 1, the FWMAV shown comprises two flapping mechanisms 5A, 5B. In the embodiment shown, an attitude controller 9 is configured to control the flapping motion induced by each of the two flapping actuators 55A, 55B separately.

As such, an attitude control mechanism 8 is provided that comprises two flapping mechanisms 5A, 5B and wherein the attitude controller 9 is configured to send a first roll signal to the first flapping mechanism 5A, e.g. to the first flapping actuator 55A and a second roll control signal to the second flapping mechanism 5B, e.g. to the second flapping actuator 55B.

The effect of the attitude control mechanism is shown more clearly in FIG. 2C, wherein the flapping motion M1 of the wings 2, 3 with respect to a flapping pivot axis F1, F2 is indicated. In a ‘normal’ condition, when there is no influence of wind, each of the wings 2, 3 may produce a lift force L, substantially equal for the first wing 2 and the second wing 3, such that the FWMAV can be stably controlled. The combined lift forces L may be substantially equal in magnitude to the mass of the FWMAV, such that the FWMAV is hanging still in the air, i.e. such that the FWMAV is hovering. The same lift force L, produced in a ‘normal’ condition, is also shown in FIGS. 2A and 2B, as will be explained further below.

When the attitude control mechanism now changes the flapping motion M1 of the first wing 2 and/or the second wing 3, a roll moment R may be induced. Changing the flapping motion M1 can for example be achieved by providing a flapping range or by providing a flapping frequency for the first wing 2 that is different from that for the second wing 3, with the latter possibility, i.e. changing the flapping frequency, shown in FIG. 2C.

When the flapping frequency is changed for the first wing 2 with respect to the second wing 3, at least a roll moment R is induced. In FIG. 2C, it is shown that by decreasing the flapping frequency of the first wing 2 a lower lift force LR1 is produced and that by increasing the flapping frequency of the second wing 3 a higher lift force LR2 is produced.

Hence, the FWMAV produces a roll moment R that is positive with respect to the X-axis X, the FWMAV rolling to the right.

Hence, shown with respect to FIGS. 1, 2C, and 3C is an attitude control mechanism configured to induce a roll moment R to the FWMAV.

Referring again to FIG. 1, it is visible that the first wing 2 and the second wing 3 are spaced apart from each other and comprise a first root spar 24 and a second root spar 34, respectively. Each root spar 24, 34 is attached to the root section 22, 32 of the respective wing membrane 21, 31.

The root spars 24, 34 are configured to pivot with respect to a pivot axis PA2 that is substantially parallel to the Y-axis Y, as is better visible with reference to FIG. 2B. By pivoting the root spars 24, 34, the inclination angle of the wing 2, 3 is changed.

The root spars 24, 34 may further be pulled inwards, i.e. in the direction of the support structure 4, increasing the tension in the wing membranes 2. When the root spars 24, 34 can be pulled inwards, they may be relatively flexible to allow this movement. However, other components of the FWMAV may also have some play to allow this movement.

When the root spars 24, 34 are pulled inwards, the movement of the root spars 24, 34 is not a pure pivotal movement with respect to the pivot axis PA2, but a combination of a translational and a pivotal movement.

The FWMAV of the shown embodiment comprises an attitude control mechanism comprising a second actuator configured to pivot the first root spar 24 and the second root spar 34 with respect to said pivot axis PA2 in substantially opposite directions for inducing a yawing moment J to the flapping wing micro aerial vehicle.

The movement J1, J2 in opposite directions is more clearly shown in FIG. 2B. Shown in FIG. 2B is the lift vector L that is generated in a normal condition. When the root spars 24, 34 are now pivoted by the attitude control mechanism, as shown, the lift vector L is tilted. In the specific example of FIG. 2B, the lift vector LJ1 of the first wing 2 is tilted in a direction parallel to the negative X-axis X, i.e. backwards, and the lift vector LJ2 of the second wing 3 is tilted in a direction parallel to the positive X-axis X, i.e. forwards. This results in the generation of a yaw moment J, in this example a yaw moment J that is positive with respect to the Z-axis Z, the FWMAV yawing in a clockwise direction.

An schematic, exemplary embodiment of an attitude control mechanism 7 is shown in FIGS. 1 and 3B. The attitude control mechanism 7 shown in FIGS. 1 and 3B comprises a control arm 72 arranged between the first wing 2 and the second wing 3, the first root spar 24 being coupled to said control arm 72 near one end thereof, and the second root spar 34 being coupled to said control arm 72 near another, opposing, end thereof, wherein said second actuator 71 is configured to pivot the control arm 72 with respect to a third pivot axis PA3 that is substantially parallel to the Z-axis Z, and wherein a pivoting movement J1, J2 of said control arm 72 increases the inclination angle of one of the first 2 and second 3 wings, and decreases the inclination angle of the other one of the first 2 and second 3 wings.

As shown in FIG. 3B, the control arm 72 comprises two holes 73, 74, arranged at opposite ends of the control arm 72. The root spars 24, 34 extend through the holes in the control arm 72, such that a pivotal movement J1, J2 with respect to a third pivot axis PA3 that is arranged substantially parallel to the Z-axis of the control arm 72 by the actuator 71, shown in FIG. 3B, results in a pivotal movement of the root spars 24, 34 with respect to the second pivot axis PA 2 that is arranged substantially parallel to the Y-axis Y, shown in FIG. 2B.

The second actuator 71 shown in FIG. 3B comprises a servomotor with a pivoting arm 75, coupled to the first 24 and second 34 root spar via the control arm 72, respectively, for controlling the movement of said first 24 and second 34 root spars.

As further visible in FIG. 1, the control arm 72 is arranged near a trailing edge of the first wing 2 and the second wing 3, respectively.

Hence, shown with respect to FIGS. 1, 2B, and 3B is an attitude control mechanism, configured to induce a yaw moment J to the FWMAV.

Referring again to FIG. 1, further shown are a support structure 4, to which the wings 2, 3, are indirectly connected, the support structure 4 extending substantially parallel to the Z-axis Z, an embodiment of an attitude control mechanism 6, configured to induce a pitch moment P to the FWMAV, and a battery 10. Said attitude control mechanism is explained in more detail with reference to FIGS. 2A, 3A, and 4.

Shown in FIG. 2A are a first wing 2 and a second wing 3, the first wing comprising first leading edge spars 51, 52 attached to the wing membrane 21 of the first wing 2 near the leading edge section thereof, and the second wing 3 comprising second leading edge spars 53, 54 attached to the wing membrane 31 of the second wing 3 near the leading edge section thereof. The first 51, 52 and second 53, 54 leading edge spars are pivotable with respect to a first pivot axis PA1 substantially parallel to the Z-axis Z, such that a pivotal movement P1, P2 of the leading edge spars 51, 52, 53, 54 can be induced.

When such a pivotal movement P1, P2 is induced, the dihedral angle of the wings 2, 3 is changed, and the lift vector LP1, LP2 is moved along a line that is substantially parallel to the X-axis X, as shown. As the movement P1, P2 of the wings 2, 3 is a pivotal movement, the lift vector LP1, LP2 will however generally not purely be moved along a line that is substantially parallel to the X-axis X, but also move inwards somewhat, i.e. along a line parallel to the Y-axis Y. This latter effect is relatively minor.

With the lift vectors LP1, LP2 being moved towards a location in front of the centre of gravity CG, in the specific example of FIG. 2A, a pitching moment M is generated that is negative with respect to the Y-axis Y.

In the specific embodiment of FIG. 3A, the first attitude control mechanism 6 comprises a first actuator 61, configured to pivot the first 51, 52 and second 53, 54 leading edge spars simultaneously in substantially the same direction with respect to a YZ-plane, for inducing a pitching moment to the flapping wing micro aerial vehicle. The pivotal movement P1, P2 of the first 51, 52 and second 53, 54 leading edge spars is indicated.

Visible in FIG. 3A is that the first actuator 61 is configured to not only pivot the first 51, 52 and second 53, 54 leading edge spars, but also the flapping actuators 55A, 55B with respect to said first pivot axis PA1.

In the specific embodiment of FIG. 3A, the first actuator 61 comprises a servomotor with at least a first 62 pivoting arm, coupled to the first 51, 52 and second 53, 54 leading edge spars via connection arms 63, 64, respectively, for controlling said pivotal movement P1, P2 of said first 51, 52 and second 53, 54 leading edge spars.

These connection arms 63, 64 are more clearly shown in FIG. 4, which shows a mutual connection between connection arms 63, 64 by means of a gear wheel. One of the connection arms 64 is connected to the pivoting arm 62 of the actuator 61, said connection arm 64 being directly controlled by the actuator 61. Due to the mutual connection of the connection arms 63, 64, when the second connection arm 64 is pivoted in a particular direction, the first connection arm 63 is similarly pivoted in the same direction with respect to the YZ-plane. Alternatively, it can be recognized that the first connection arm 63 and the second connection arm 64 are rotated in opposite directions.

In the embodiment shown, the connection arms 63, 64 are each connected to a frame 56A, 56B of the flapping actuator 55A, 55B, respectively, and can influence the position of this frame 56A, 56B. As both the leading edge spars 51, 52, 53, 54 as well as the movement of the root spar 24, 34 will effect a movement of the leading edge spar 51, 52, 53, 54, as these are mutually connected via flapping actuators 55A and 55B respectively.

Referring again to FIG. 1, the FWMAV further comprises an attitude controller 9, configured to generate respectively a pitch control signal for controlling said first attitude control mechanism 6 to induce a pitch moment P, a yaw control signal for controlling said second attitude control mechanism 7 to induce a yaw moment J, and two roll control signals for controlling said third attitude control mechanism 8 to induce a roll moment R.

Further with reference to FIG. 1, a FWMAV is shown comprising a first attitude control mechanism 6, the second attitude control mechanism 7, and the third attitude control mechanism 8, which are embodied as separate mechanisms.

More specifically, the first attitude control mechanism 6 is advantageously configured to induce only a pitch moment P, the second attitude control mechanism 7 is configured to induce only a yaw moment J, and the third attitude control mechanism 8 is configured to induce only a roll moment R.

As explained in detail above, a flapping wing aerial vehicle 1, for which an imaginary right-hand sided axis system comprising an X-axis X, a Y-axis Y, and a Z-axis Z is defined, comprises:
at least a first wing 2 and a second wing 3, the second wing 3 being opposite to the first wing 2, each wing 2, 3 comprising a wing membrane 21, 31, a root section 22, 32, and a leading edge section 23, 33;
a support structure 4, to which the wings 2, 3 are directly or indirectly connected, the support structure 4 extending substantially parallel to the Z-axis Z;
at least one flapping mechanism 5, 5A, 5B, comprising at least a first spar 51, 52, 53, 54 and a flapping actuator 55, 55A, 55B, the at least a first spar 51, 52, 53, 54 being attached to the wing membrane 21, 31 of the first wing 2 and/or the second wing 3, the flapping actuator 55, 55A, 55B being configured to pivot said at least one spar 51, 52, 53, 54 with respect to a flapping pivot axis F1, F2 substantially parallel to the Z-axis Z for inducing a flapping motion M1 of said first wing 2 and/or second wing 3;
a first attitude control mechanism 6, configured to induce a pitch moment P to the flapping wing aerial vehicle;
a second attitude control mechanism 7, configured to induce a yaw moment J to the flapping wing aerial vehicle;
a third attitude control mechanism 8, configured to induce a roll moment R to the flapping wing aerial vehicle;
an attitude controller 9, configured to generate respectively a pitch control signal for controlling said first attitude control mechanism 6 to induce a pitch moment P, a yaw control signal for controlling said second attitude control mechanism 7 to induce a yaw moment J, and roll control signal for controlling said third attitude control mechanism 8 to induce a roll moment R;
   wherein the first attitude control mechanism 6, the second attitude control mechanism 7, and the third attitude control mechanism 8 are separate mechanisms. The first and second wings 2, 3 respectively comprise first 51, 52 and second 53, 54 leading edge spars being pivotable with respect to a first pivot axis PA1 substantially parallel to the Z-axis. The first attitude control mechanism 6 comprises a first actuator 61, configured to pivot the first 51, 52 and second 53, 54 leading edge spars simultaneously in substantially the same direction with respect to a YZ-plane. The first actuator 61 is configured to pivot the first 51, 52 and second 53, 54 leading edge spars and the flapping actuator 55, 55A, 55B with respect to said first pivot axis PA1.

As required, detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a”/“an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

The term coupled, as used herein, is defined as connected, although not necessarily directly.

1.-12. (canceled)

13. A flapping wing aerial vehicle, for which an imaginary right-hand sided axis system comprising an X-axis, a Y-axis, and a Z-axis is defined, the flapping wing aerial vehicle comprising:
at least a first wing and a second wing, the second wing being opposite to the first wing, each wing comprising a wing membrane, a root section, and a leading edge section;
a support structure, to which the wings are directly or indirectly connected, the support structure extending substantially parallel to the Z-axis;
at least one flapping mechanism, comprising at least a first spar and a flapping actuator, the at least a first spar being attached to the wing membrane of the first wing and/or the second wing, the flapping actuator being configured to pivot said at least one spar with respect to a flapping pivot axis substantially parallel to the Z-axis for inducing a flapping motion of said first wing and/or second wing;
a first attitude control mechanism, configured to induce a pitch moment to the flapping wing aerial vehicle; and
an attitude controller, configured to generate respectively a pitch control signal for controlling said first attitude control mechanism to induce a pitch moment;
wherein the first wing comprises a first leading edge spar and the second wing comprises a second leading edge spar, said first and second leading edge spars being pivotable with respect to a first pivot axis substantially parallel to the Z-axis, allowing the dihedral angle of the corresponding wing to be changed,
wherein the first attitude control mechanism comprises a first actuator, configured to pivot the first and second leading edge spars simultaneously in substantially the same direction with respect to a YZ-plane, for inducing a pitch moment to the flapping wing aerial vehicle, and
wherein the first actuator is configured to pivot the first and second leading edge spars and the flapping actuator with respect to said first pivot axis.

14. The flapping wing aerial vehicle according to claim 13, wherein the first actuator comprises a servomotor with at least a first pivoting arm, coupled to the first and second leading edge spars, respectively, for controlling a pivotal movement of said first and second leading edge spars.

15. The flapping wing aerial vehicle according to claim 13, wherein the first wing and the second wing are spaced apart from each other and comprise a first root spar and a second root spar, respectively, attached to the root section of the respective wing membrane, and wherein the root spars are configured to pivot with respect to a second pivot axis that is substantially parallel to the Y-axis, allowing the inclination angle of the corresponding wing to be changed.

16. The flapping wing aerial vehicle according to claim 15, further comprising a second attitude control mechanism, configured to induce a yaw moment to the flapping wing aerial vehicle, wherein the first attitude control mechanism and the second attitude control mechanism are separate mechanisms, and wherein the second attitude control mechanism comprises a second actuator configured to pivot the first and second root spars with respect to said second pivot axis in substantially opposite directions for inducing a yaw moment to the flapping wing aerial vehicle.

17. The flapping wing aerial vehicle according to claim 16, wherein the second attitude control mechanism further comprises a control arm arranged between the first wing and the second wing, the first root spar being coupled to said control arm near one end thereof, and the second root spar being coupled to said control arm near another, opposing, end thereof, wherein said second actuator is configured to pivot the control arm with respect to a third pivot axis that is substantially parallel to the Z-axis, and wherein a pivoting movement of said control arm increases the inclination angle of one of the first and second wings, and decreases the inclination angle of the other one of the first and second wings.

18. The flapping wing aerial vehicle according to claim 17, wherein the control arm is arranged near a trailing edge of the first wing and the second wing, respectively.

19. The flapping wing aerial vehicle according to claim 16, wherein the second actuator comprises a servomotor with a pivoting arm, coupled to the first and second root spar, respectively, for controlling the movement of said first and second root spars.

20. The flapping wing aerial vehicle according to claim 13, further comprising a third attitude control mechanism, configured to induce a roll moment to the flapping wing aerial vehicle, wherein the first attitude control mechanism and the third attitude control mechanism are separate mechanisms, and wherein the third attitude control mechanism is configured to induce a roll moment to the flapping wing aerial vehicle by changing the flapping motion of the first and/or the second wing, for example by providing a flapping frequency and/or a flapping range for the first wing that is different from that for the second wing.

21. The flapping wing aerial vehicle according to claim 13, comprising two flapping mechanisms, each flapping mechanism comprising a spar that is attached to the wing membranes of the first wing, respectively, the second wing, and a flapping actuator, wherein the attitude controller is configured to control the flapping motion induced by each of the two flapping actuators separately.

22. The flapping wing aerial vehicle according to claim 20, wherein the third attitude control mechanism comprises two flapping mechanisms, and wherein the attitude controller is configured to send a first roll signal to the first flapping mechanism and a second roll control signal to the second flapping mechanism.

23. The flapping wing aerial vehicle according to claim 13, wherein the first attitude control mechanism is configured to induce only a pitch moment.

24. The flapping wing aerial vehicle according to claim 16, wherein the second attitude control mechanism is configured to induce only a yaw moment.

25. The flapping wing aerial vehicle according to claim 20, wherein the third attitude control mechanism is configured to induce only a roll moment.

26. The flapping wing aerial vehicle according to claim 13, wherein the first wing and the second wing each comprise a back wing portion and a front wing portion, adjoined at the root section of the wing, wherein the back wing portion and the front wing portion are configured to move away from and towards each other when a flapping motion of the wing is induced.
